(19) United States
(12) Patent Application Publication
(10) Pub. No.: US 2010/0162584 A1
(43) Pub. Date: Jul. 1, 2010

(54) DEHUMIDIFYING APPARATUS FOR DRYER

(76) Inventors: Seung-Phyo Ahn, Gyeongsangnam-Do (KR); Sang-Ik Lee, Gyeongsangnam-Do (KR); Byeong-Jo Ryoo, Gyeongsangnam-Do (KR); Sung-Ho Song, Gyeongsangnam-Do (KR); Jeong-Yun Kim, Gyeongsangnam-Do (KR); Yang-Hwan Kim, Gyeongsangnam-Do (KR); Jac-Hyuk Wee, Gyeongsangnam-Do (KR); Dong-Hyun Kim, Gyeongsangnam-Do (KR); Yoon-Seob Eom, Gyeongsangnam-Do (KR); Yang-Ho Kim, Gyeongsangnam-Do (KR)

Correspondence Address: KED & ASSOCIATES, LLP, P.O. Box 221200, Chantilly, VA, 20153-1200, US

(21) Appl. No.: 12/676,228

(22) PCT Filed: Sep. 3, 2008
(86) PCT No.: PCT/KR08/05182

§ 371 Date: Mar. 3, 2010

(30) Foreign Application Priority Data
Sep. 4, 2007 (KR) 10-2007-0089676

(51) Int. Cl. F26B 21/08; D06F 58/04; F16K 21/18

(52) U.S. Cl. 34/73; 34/130; 137/386

(57) ABSTRACT

Disclosed is the dehumidifying apparatus for a dryer comprising: a case; a drum disposed inside the case and for receiving objects to be dried therein; and a hot air supplying unit for supplying hot air into the drum and drying the objects to be dried, the dehumidifying apparatus, comprising: a dehumidifying unit having a heat exchanger for cooling hot air flowing from the drum; and a water tank for containing a fluid supplied to the heat exchanger, wherein the fluid circulates between the heat exchanger and the water tank. The dehumidifying apparatus for a dryer may reduce an amount of water used for operating the dryer, prevent the waste of water, and stably supply recycled cool water to the heat exchanger from the water tank.

### TECHNICAL FIELD

The present invention relates to a dehumidifying apparatus for a dryer, and more particularly, to an apparatus for removing moisture contained in air exhausted when drying objects to be dried received in a dryer.

### BACKGROUND ART

In general, a clothes dryer is a device that absorbs moisture from objects to be dried (load) by blowing hot air generated by a heater into a drum and thereby dries the load. Clothes dryers may be roughly categorized into an exhaust type clothes dryer and a condensation type clothes dryer, according to the method employed for handling the humid air occurring when absorbing the moisture and drying the load.

The exhaust type clothes dryer employs a method for exhausting the humid air flowing from the drum to the outside of the dryer. However, it requires an exhaust duct for exhausting the moisture evaporated in the drum to the outside. In particular, when gas heating is employed, the exhaust duct needs to be installed being extended long enough to the outdoors, considering that carbon monoxide, etc. as a product of combustion are also exhausted.

Meanwhile, the condensation type clothes dryer uses a recirculation method that removes moisture by condensing the moisture from the humid air flowing from the drum in a heat exchanger and then re-circulates the moisture-removed dry air back into the drum. However, the drying air flow forms a closed loop, making it difficult to use gas as a heating source.

A ductless dryer overcomes the demerits of the exhaust type dryer and the condensation type dryer. The ductless dryer supplies hot air by using gas as a heating source, and uses a water cooling type heat exchanger to remove moisture from air of high temperature after drying objects to be dried, and then exhausts the moisture-removed dry air to the outside. Accordingly, the ductless dryer can be maintained at a low cost by using gas as the heating source and does not require an additional exhaust duct to be extended to the outdoors.

Meanwhile, the water cooling type heat exchanger needs to be supplied with cold water for heat exchange with air of high temperature. Such cold water is supplied from an external storage tank such as a water supply, etc., and water heat-exchanged with the air of high temperature in the heat exchanger is exhausted to the outside. Accordingly, an amount of water consumed to remove the moisture during an operation of the dryer would increase.

### DISCLOSURE OF INVENTION

### Technical Problem

Therefore, an object of the present invention is to provide a dehumidifying apparatus for a dryer which has a structure to reduce an amount of water consumed during operation of the dryer.

### Technical Solution

According to one aspect of the present invention, there is provided a dehumidifying apparatus for a dryer comprising: a case; a drum disposed inside the case and for receiving objects to be dried therein; and a hot air supplying unit for supplying hot air into the drum and drying the objects to be dried, the dehumidifying apparatus, comprising: a dehumidifying unit having a heat exchanger for cooling hot air flowing from the drum; and a water tank for containing a fluid supplied to the heat exchanger, wherein the fluid circulates between the heat exchanger and the water tank.

In the dehumidifying apparatus for a dryer according to one aspect of the present invention, heat-exchanged waste water flowing from the heat exchanger is supplied to the water tank and cooled so as to be reused as cooling water for the heat exchanger, thereby reducing an amount of water consumed for operation of the dryer and preventing the waste of water.

In addition, according to the dehumidifying apparatus for a dryer, a partition wall is disposed inside the water tank and a plurality of receiving units are formed, thus to enable the waste water introduced into the water tank to sequentially pass the plurality of receiving units. During such process, water temperature gradually drops, and mixture of water in each receiving unit is minimized, thereby maintaining a dropped water temperature. Accordingly, even though water of high temperature is supplied to the receiving units connected to a water tank connection pipe, water cooled by being received in the receiving units connected to a storage water supply pipe is supplied to the heat exchanger, thusly to be cool water enough to be utilized as cooling water. Therefore, the recycled cool water can be stably supplied to the heat exchanger from the water tank.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic view of a dryer to which a dehumidifying apparatus is employed according to a first embodiment of the present invention;

FIG. 2 is a plane view showing the dryer to which the dehumidifying apparatus is employed according to the first embodiment of the present invention;

FIG. 3 is a perspective view showing that the dehumidifying apparatus for the dryer is installed according to the first embodiment of the present invention;

FIG. 4 is a rear perspective view showing that a water tank of the dehumidifying apparatus for the dryer is installed according to the first embodiment of the present invention;

FIG. 5 is a rear perspective view showing that heat is exchanged in a heat exchanger while fresh water is supplied through a fresh water supply pipe in the first embodiment of the present invention;

FIG. 6 is a rear perspective view showing that water oversupplied to the water tank is drained in the first embodiment of the present invention;

FIG. 7 is a rear perspective view showing that heat is exchanged in a heat exchanger while stored water is supplied through a storage water supply pipe in the first embodiment of the present invention;

FIG. 8 is a rear perspective view showing that a dehumidifying apparatus for a dryer is installed according to a second embodiment of the present invention;

FIG. 9 is a vertical cross-sectional view of a water tank in the second embodiment of the present invention; and

FIG. 10 is a vertical cross-sectional view of a flow within the water tank in the second embodiment of the present invention.

### MODE FOR THE INVENTION

Description will now be given in detail of the preferred embodiments of the present invention, examples of which are illustrated in the accompanying drawings. Here, the dehumidifying apparatus for a dryer is not limited to a ductless dryer which discharge the dehumidified air to the outside of the body, but may also be applied to various types of dryers, such as a general condensation type or circulation type dryer, and the like.

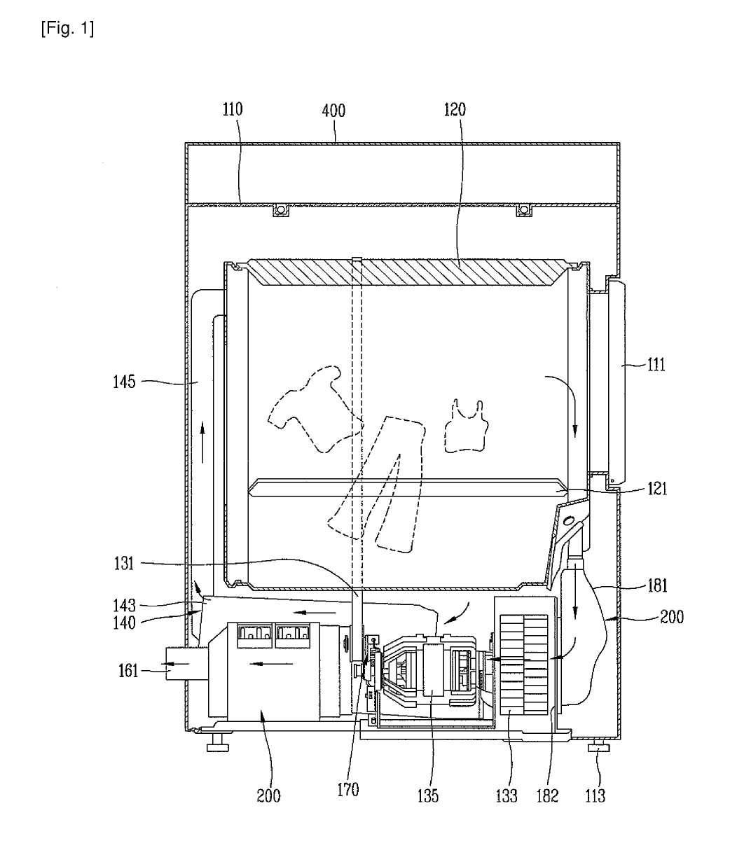

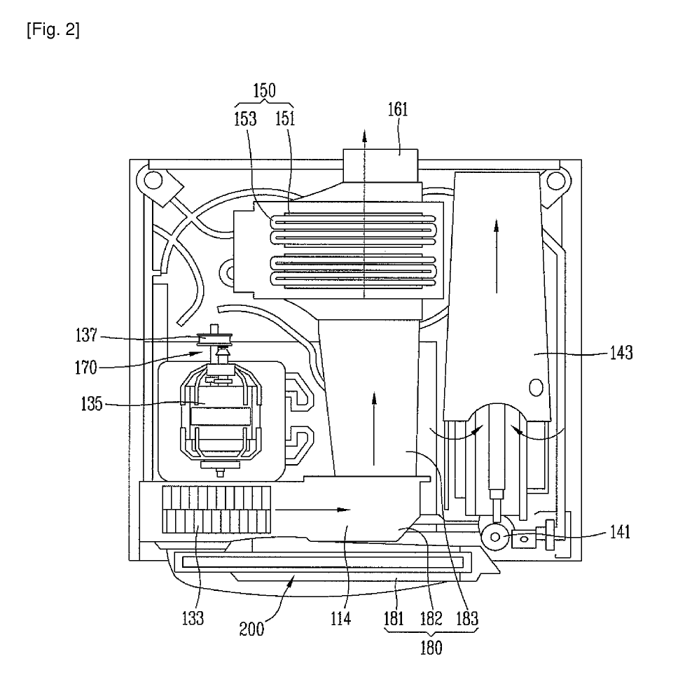

FIG. 1 is a schematic view of a dryer to which a dehumidifying apparatus is employed according to a first embodiment of the present invention. FIG. 2 is a plane view showing the dryer to which the dehumidifying apparatus is employed according to the first embodiment of the present invention. Arrows indicate the flow of air.

Referring to FIGS. 1 and 2, the ductless dryer according to a first embodiment of the present invention may include a main body 110; a drum 120 rotatably mounted at the main body 110; a hot air supplying unit 140 supplying hot air into the drum 120; a heat exchanger 150 removing moisture contained in the air exhausted from the drum 120; a circulation duct 180 conducting the air exhausted from the drum 120 to the heat exchanger 150; a filter 200 installed in the circulation duct 180 and filtering lint contained in the air coming out of the drum 120; and a sealing unit S preventing the leakage of lint through a gap of an installation portion where the filter 200 is installed.

A door 111 is mounted on a front surface of the main body 110 to enable loading of clothes into the drum 120. A foot 113 is disposed at a lower portion of the main body 110 to support the main body 110. A belt 131 for rotating the drum 120 and a motor 135 for supplying a driving force to the belt 131 are mounted inside the main body 110. A pulley 137 for winding the belt 131 is disposed on a shaft of the motor 135.

The drum 120 is a container having an inner space into which clothes, etc., as objects to be dried, can be loaded. A plurality of lifters 121 are installed inside the drum 120 so as to lift the clothes.

The hot air supplying unit 140 includes a valve 141 controlling the supplying of gas, a gas burner 143 mixing the gas supplied from the valve 141 with an air supplied from the outside, igniting it, and then generating hot air, and a hot air supplying duct 145 communicating the gas burner 143 with the drum 120 so as to supply the generated hot air to the drum 120. In order to indirectly determine the amount of carbon monoxide (CO) emissions through a numerical value of a flame current by detecting the flame current, a flame rod extending to an edge of a flame may be installed in the hot air supplying unit 140.

Preferably, the valve 141 is implemented as a solenoid valve so as to sensitively adjust the amount of gas supplied.

While being supplied by the valve 141, the gas burner 143 heats the air with the heat generated when the gas supplied from the valve 141 is mixed with the outside air and then burned. The hot air generated by being thusly heated is provided to the drum 120 through the hot air supplying duct 145.

The heat exchanger 150 includes fins 151 and a tube 153. The heat exchanger 150 condenses moisture from the air of high temperature and humidity coming out of the drum 120 through a heat exchange method of air to water by using water of low temperature, to thereby dry the air. An inlet of the heat exchanger 150 is connected to the drum 120 by the circulation duct 180, and an outlet thereof is connected to an exhaust duct 161. That is, the air discharged to the outside through the exhaust duct 161 via the heat exchanger 150.

The heat exchanger 150 may be defined as a temperature-humidity controller for controlling at least one of temperature or humidity of gas coming out of the drum 120. Here, the heat exchanger 150 is described as an exemplary temperature-humidity controller, but various types of temperature-humidity controllers may also be employed.

The fins 151 are thin metallic plates having excellent thermal conductivity and are laminated as a plurality of thin vertical metallic plates having a minute distance therebetween so as to contact the air of high temperature and humidity as it passes through.

Water of low temperature (22° C.) is circulated through the tube 153. The tube 153 penetrates the fins 151 in a serpentine manner. Both ends of the tube 153 are connected to water lines (not shown) for supplying and draining water of low temperature. A water container (not shown) for collecting condensed water, which is generated during the condensation process and dropped, is installed at a lower portion of the heat exchanger 150.

The circulation duct 180 includes a filter installation duct 181 providing a space where the filter 200 is installed, a fan installation duct 182 connected to the filter installation duct 181 and providing a space where the fan 133 is installed, and a connection duct 183 for connecting the fan installation duct 182 and the heat exchanger 150. Here, the fan 133 is connected to a shaft of the motor 135 and is supplied a driving force from the motor 135. To be certain, a plurality of motors 135 may be provided so as to respectively supply a driving force to the belt 131 and the fan 133.

Meanwhile, a water tank 400 is disposed on the dryer main body 110 so as to store water flowing from the heat exchanger 150 for water-cooling, cool the stored water, and then re-circulate the water back to the heat exchanger 150. The water tank 400 will be described later.

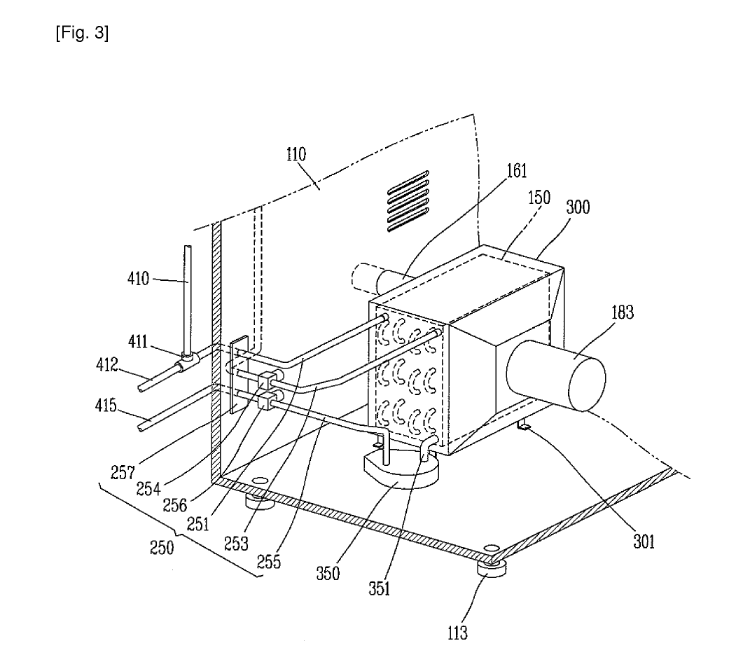

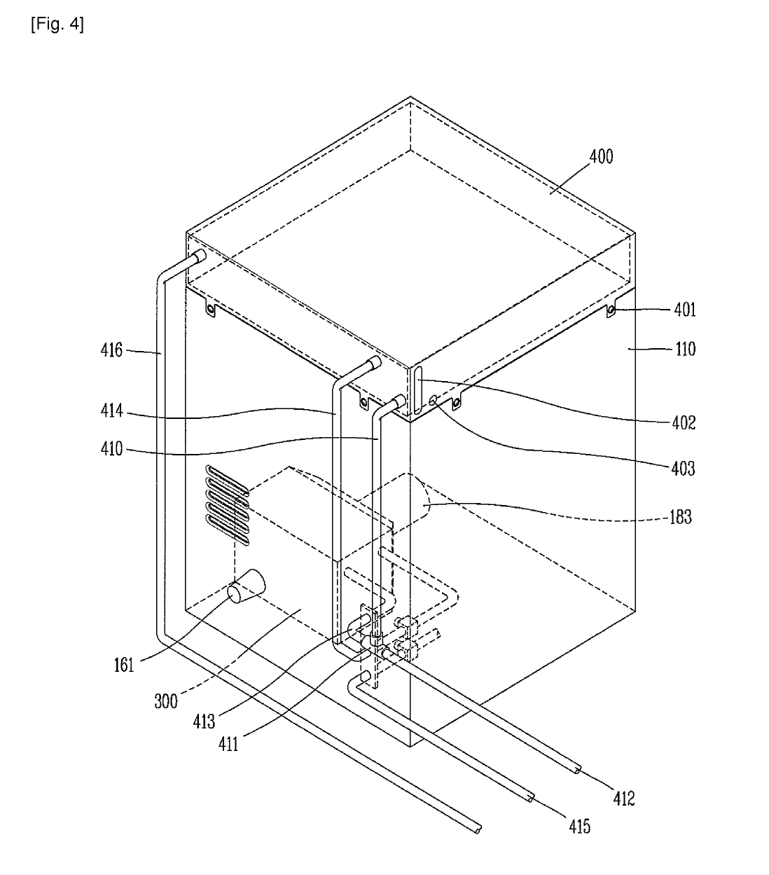

FIG. 3 is a perspective view showing that the dehumidifying apparatus for the dryer is installed according to the first embodiment of the present invention. FIG. 4 is a rear perspective view showing that a water tank of the dehumidifying apparatus for the dryer is installed according to the first embodiment of the present invention.

Referring to FIGS. 3 and 4, the heat exchanger 150 and a controller case 300 for covering the heat exchanger 150 are formed at a lower surface of the dryer main body 110 according to this embodiment. The connection duct 183 is communicated with one side of the controller case 300, and the exhaust duct 161 is communicated with another side thereof.

The heat exchanger 150 is installed inside the controller case 300 which entirely covers the heat exchanger 150. The controller case 300 may be tightly sealed so as to maintain its sealed state.

A refrigerant flowing through the tube 153 is heat-exchanged with air introduced from the drum 120 through the connection duct 183 in the heat exchanger 150. Water may be used as such refrigerant. During the heat exchange, the moisture contained in the air is condensed, thereby generating condensate water. The condensate water flows along the heat exchanger 150, and is directed to the lower portion of the controller case 300.

The lower portion of the controller case 300 serves as a container (water tank) for containing the condensate water flowing down from the heat exchanger 150. A lowermost water tank 350 is disposed at one side of the controller case 300 so as to be communicated with the lower portion of the controller case 300 (i.e., the water tank) by a communication pipe 351.

The lowermost water tank 350 is disposed at a relatively lower position than the water tank (i.e., the lower portion of the controller case 300). Accordingly, the condensate water contained in the lower portion of the controller case 300 may be introduced to the lowermost water tank 350.

The lowermost water tank 350 is connected to a condensate water outlet pipe 255. The lowermost water tank 350 may further include a pump. Then, the condensate water received in the lowermost water tank 350 by the pump may be drained to the outside through the condensate water outlet pipe 255.

Meanwhile, the condensate water outlet pipe 255, a refrigerant inlet pipe 251, a refrigerant outlet pipe 253, and a pipe coupling plate 257 may form to be one assembly for modularization. Such module is implemented as a pipe module 250 as shown in FIG. 3. The modularization of the pipes facilitates installation and removal processes of the pipes.

Here, the refrigerant inlet pipe 251 is a path (passage) through which a refrigerant (e.g., water) is introduced to the heat exchanger 150 from the outside. The refrigerant outlet pipe 253 is a path (passage) through which the refrigerant flowing from the heat exchanger 150 is discharged to the outside.

Reference numerals 254 and 256 denote control valves for each pipe. The control valve is implemented as a solenoid valve.

In this embodiment, the water tank 400 is coupled to the upper side of the dryer main body 110 by coupling units 401. The water tank 400 is disposed at a relatively higher position than the upper portion of the dryer main body 110 (e.g., the heat exchanger 150). The water tank 400 stores and cools water from the heat exchanger 150. In this embodiment, the water stored in the water tank 400 is air-cooled.

Since the water tank 400 is coupled to the dryer main body 110 by using the coupling units 401, if coupling of the coupling units 401 is released, the water tank 400 may be detached from the dryer main body 110. Thusly, the water tank 400 may be attached to and detached from the dryer main body 110.

An opening/closing valve 411 is installed at an inlet side of the refrigerant inlet pipe 251, and the opening/closing valve 411 is communicated with a fresh water supply pipe 412 and a storage water supply pipe 410. The fresh water supply pipe 412 is a pipe which supplies water from an outside by being connected to an external storage tank (e.g., public water pipes, etc.). And, the storage water supply pipe 410 is a pipe which supplies water stored in the water tank 400.

The opening/closing valve 411 may selectively open/close the fresh water supply pipe 412 and the storage water supply pipe 410 according to a control signal of a controller. Water, having passed through the opening/closing valve 411, is introduced into the heat exchanger 150 through the refrigerant inlet pipe 251 for heat exchange.

A water tank connection pipe 414 is connected at an outlet side of the refrigerant outlet pipe 253. The water tank 400 is connected to another side of the water tank connection pipe 414. To prevent water from flowing backward, the water tank connection pipe 414 may be connected to the upper portion of the water tank 400. Water flowing from the heat exchanger 150 through the water tank connection pipe 414 is thusly introduced and stored in the water tank 400.

The refrigerant outlet pipe 253 and the water tank 400 are respectively connected by the water tank connection pipe 414. If a pressure level of fresh water supplied is greater than a predetermined level, the pressure of the fresh water within the fresh water supply pipe 412 is sequentially applied to the water tank connection pipe 414. Then, by such pressure, the water rises along the water tank connection pipe 414, thus to reach the water tank 400.

Meanwhile, a water level sensor 402 may be installed at the water tank 400. The water level sensor 402 is configured to sense (detect) a level of water stored in the water tank 400 and transfer such information to the controller. If the water tank 400 is sensed to be filled with water (i.e., high water level) by the water level sensor 402, the opening/closing valve 411 is activated to close the fresh water supply pipe 412. Accordingly, the flow of water to the water tank 400 is stopped.

In addition, a water temperature sensor 403 may be installed at the water tank 400. The water temperature sensor 403 is configured to sense (detect) temperature of water stored in the water tank 400. A thusly sensed temperature value is used as information to determine whether or not the stored water is cooled enough to be supplied to the heat exchanger 150. According to the detected water temperature by the water temperature sensor 403, it is determined whether or not the fresh water is supplied from the water tank 400 to the heat exchanger 150.

In addition, the water tank 400 may be communicated with a drain pipe 416. The drain pipe 416 is a pipe to drain oversupplied water stored in the water tank 400 to the outside. To enable this function, preferably, the drain pipe 416 is connected to the upper portion of the water tank 400.

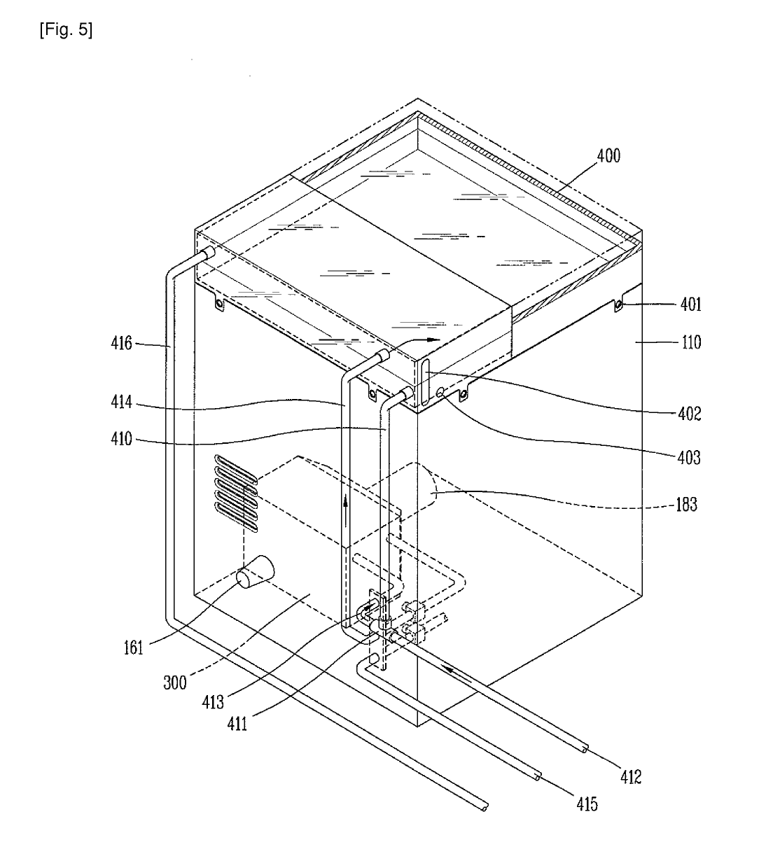

FIGS. 5 through 7 are views illustrating operations of the dehumidifying apparatus for a dryer according to the first embodiment of the present invention.

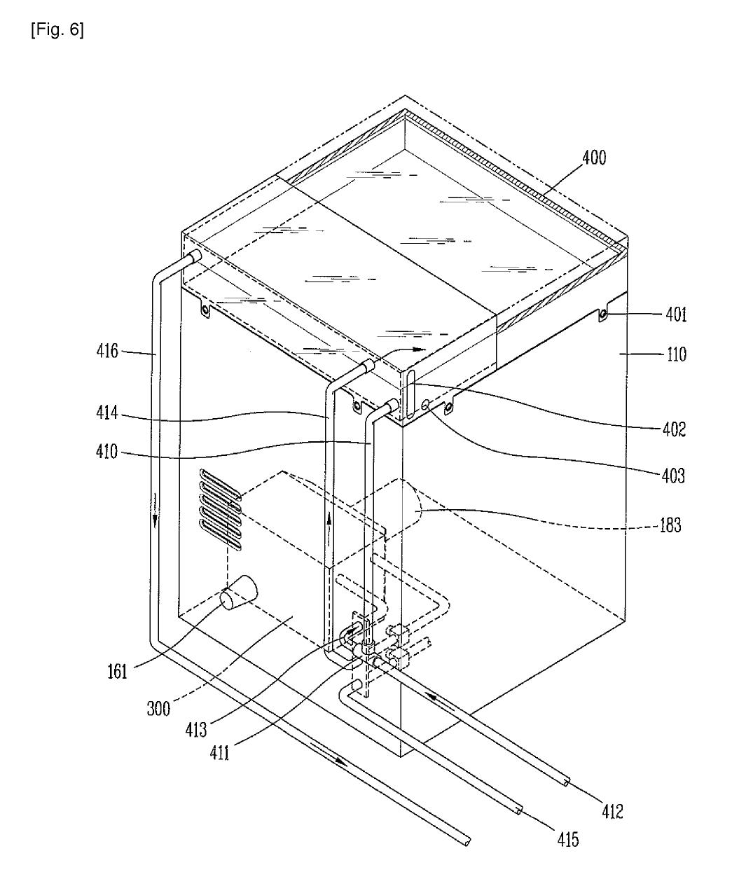

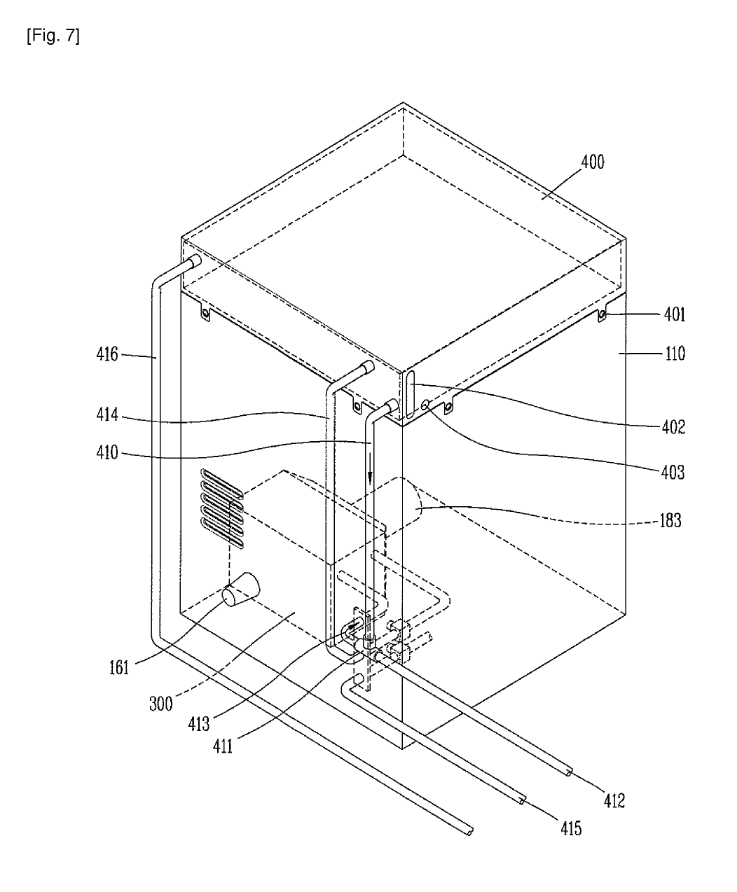

FIG. 5 is a rear perspective view showing that heat is exchanged in a heat exchanger while fresh water is supplied through a fresh water supply pipe in the first embodiment of the present invention. FIG. 6 is a rear perspective view showing that water oversupplied to the water tank is drained in the first embodiment of the present invention. FIG. 7 is a rear perspective view showing that heat is exchanged in a heat exchanger while stored water is supplied through a storage water supply pipe in the first embodiment of the present invention.

Hereinafter, description of the dehumidifying apparatus for a dryer according to the first embodiment of the present invention will be give in detail with reference to FIGS. 5 through 7.

Referring to FIG. 5, the opening/closing valve 411 is configured to open the fresh water supply pipe 412 and close the storage water supply pipe 410. Then, fresh water is supplied from the external storage tank through the fresh water supply pipe 412. The supplied fresh water is introduced to the heat exchanger 150 through the opening/closing valve 411 and the refrigerant inlet pipe 251.

Water supplied to the heat exchanger 150 is circulated through the tube 153 of the heat exchanger 150, and heat-exchanged with gas applied to the heat exchanger 150, thus to be heated.

The thusly heated water is introduced into the water tank 400 through the refrigerant outlet pipe 253 and the water tank connection pipe 414. Here, water flows toward the water tank 400 by the pressure transferred from the fresh water.

If water is supplied to the water tank 400 through the water tank connection pipe 414, the water level sensor 402 detects the water level in the water tank 400. If a water level is detected to be greater than a predetermined reference value, the opening/closing valve 411 is activated, thereby stopping the fresh water supply. Here, if the fresh water should continue to be supplied (e.g., the dryer needs to be operated), water may continuously be supplied to the water tank 400. The oversupplied water may be drained to the outside through the drain pipe 416, as shown in FIG. 6.

Meanwhile, water supplied to the water tank 400 is cooled down at a certain level of temperature by air-cooling. Then, the water temperature sensor 403 detects the water temperature in the water tank 400. According to the detected value, the controller determines whether or not the water in the water tank 400 is cooled enough to be used as cooling water for the heat exchanger 150.

If the dryer started an operation and the water temperature in the water tank 400 has reached a certain required value, the opening/closing valve 411 maintains the closed state of the fresh water supply pipe 412, and then opens the storage water supply pipe 410. Then, water stored in the water tank 400 is supplied to the heat exchanger 150 through the storage water supply pipe 410, the opening/closing valve 411 and the refrigerant inlet pipe 251, thereby being heat-exchanged.

As so far described, water from the heat exchanger 150 is stored, without being drained, and cooled in the water tank 400, and then is supplied to the heat exchanger 150 to be reused as cooling water, thereby reducing the amount of water used for operation of the dryer, and preventing the waste of water.

Hereinafter, the second embodiment of the present invention will be described in detail. Same explanations as those given in the first embodiment of the present invention are omitted.

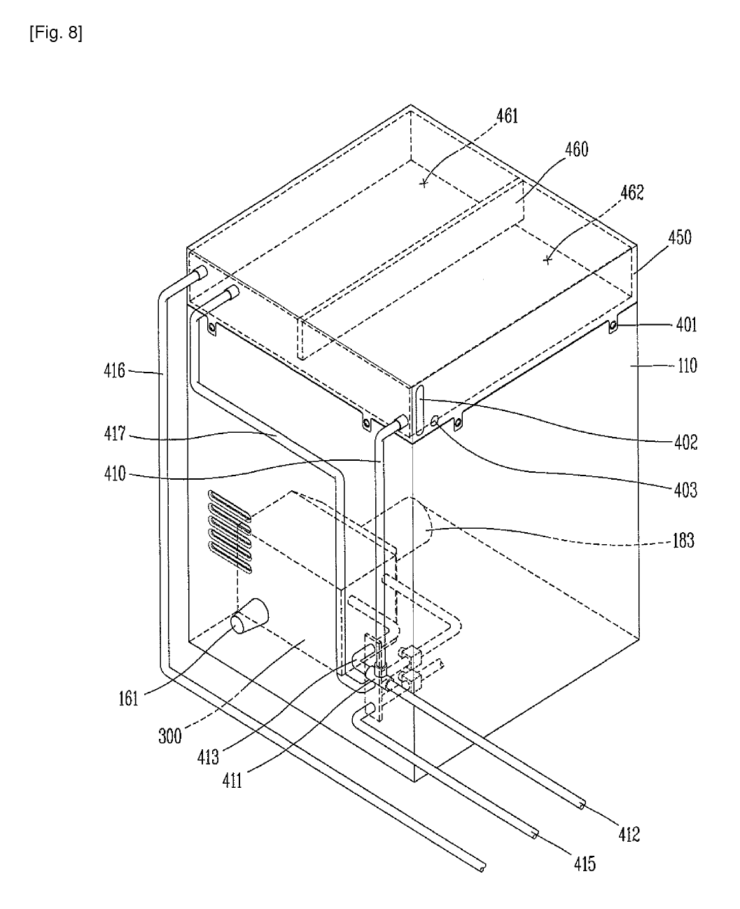

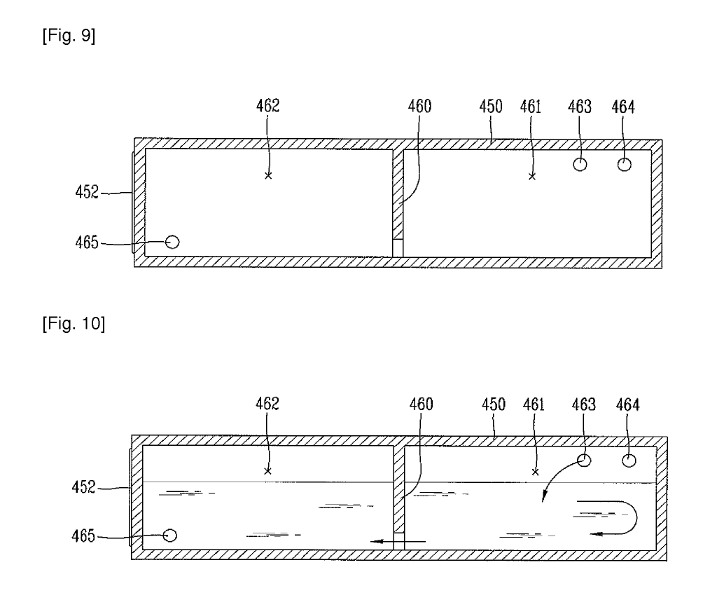

FIG. 8 is a rear perspective view showing that a dehumidifying apparatus for a dryer is installed according to a second embodiment of the present invention. FIG. 9 is a vertical cross-sectional view of a water tank in the second embodiment of the present invention, and FIG. 10 is a vertical cross-sectional view of a flow within the water tank in the second embodiment of the present invention.

Referring to FIGS. 8 through 10, a water tank connection pipe 417 connected to a refrigerant outlet pipe 253 is connected to a water tank 450 according to this embodiment.

An inner space of the water tank 450 is divided into a first receiving unit 461 and a second receiving unit 462 by a partition wall 460. The first and second receiving units 461, 462 are sequentially disposed according to a direction of water flow. This partition wall 460 extends from an upper portion of the water tank 450 toward a lower portion thereof, and a lower end of the partition wall 460 is spaced from a bottom surface of the water tank 450 such that water is circulated through a space (gap) between the lower end thereof and the bottom surface.

Here, the number of partition walls 460 and the receiving units 461, 462 are merely exemplary, and to be certain, a plurality of partition walls and the receiving units may be formed.

Reference numeral 463 denotes an opening communicated with the water tank connection pipe 417, reference numeral 464 denotes an opening communicated with the drain pipe 416, and reference numeral 465 denotes an opening communicated with the storage water supply pipe 410.

The water tank connection pipe 417 is connected to an upper portion of the first receiving unit 461. Then, water flowing from the heat exchanger 150 is introduced into the first receiving unit 461 through the refrigerant outlet pipe 253 and the water tank connection pipe 417.

Water introduced into the first receiving unit 461 is primarily cooled in the first receiving unit 461, and then flows to the second receiving unit 462 through the space (gap) between the partition wall 460 and the bottom surface of the water tank 450. Water in the second receiving unit 462 is air-cooled.

Since water of high temperature is continuously introduced into the first receiving unit 461, average water temperature in the first receiving unit 461 is higher than that in the second receiving unit 462.

As water introduced into the water tank 450 sequentially passes through the receiving units 461, 462, water temperature gradually drops, and mixture of water in each receiving unit is minimized, thereby maintaining a dropped water temperature. Accordingly, even though water of high temperature is supplied to the first receiving unit 461, water cooled in the second receiving unit 462 is supplied to the heat exchanger 150 while maintaining the water to be cool enough to be used as cooling water. Therefore, recycled cool water may be stably supplied to the heat exchanger 150 from the water tank 450.

According to the dehumidifying apparatus for a dryer in one aspect of the present invention, waste water having heat-exchanged in the heat exchanger is supplied to the water tank, and is then cooled to be reused as cooling water for the heat exchanger, thereby reducing the amount of water for operating the dryer as well as preventing the waste of water.

In addition, according to the dehumidifying apparatus for a dryer, the partition wall is installed inside the water tank and a plurality of receiving units are formed, thereby enabling waste water introduced into the water tank to sequentially pass the plurality of receiving units. During this process, water temperature gradually drops, and mixture of water in each receiving unit is minimized, thereby maintaining a dropped water temperature. Accordingly, even though water of high temperature is supplied to the receiving units connected to the water tank connection pipe, water stored and cooled in the receiving units connected to the storage water supply pipe is supplied to the heat exchanger, thus to maintain the water to be cool enough to be used as cooling water. Therefore, recycled cool water is stably supplied to the heat exchanger from the water tank.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1. A dehumidifying apparatus for a dryer comprising:
a case;
a drum disposed inside the case and for receiving objects to be dried therein; and
a hot air supplying unit for supplying hot air into the drum and drying the objects to be dried, the dehumidifying apparatus, comprising:
a dehumidifying unit having a heat exchanger for cooling hot air flowing from the drum; and
a water tank for containing a fluid supplied to the heat exchanger, wherein the fluid circulates between the heat exchanger and the water tank.

2. The dehumidifying apparatus for a dryer of claim 1, further comprising an exhaust duct which discharges the air through the dehumidifying units to the outside of the case.

3. The dehumidifying apparatus for a dryer of claim 1, wherein the water tank is disposed at an upper position than the heat exchanger.

4. The dehumidifying apparatus for a dryer of claim 1, wherein the water tank is disposed above the case.

5. The dehumidifying apparatus for a dryer of claim 1, further comprising: a fresh water supply pipe for supplying a fluid from an external storage tank toward the heat exchanger.

6. The dehumidifying apparatus for a dryer of claim 5, wherein if the fluid is supplied through the fresh water supply pipe at a pressure greater than a predetermined pressure, the fluid flowing from the heat exchanger is able to flow to the water tank.

7. The dehumidifying apparatus for a dryer of claim 1, wherein the water tank is provided with a drain pipe for draining a fluid supplied more than a predetermined amount.

8. The dehumidifying apparatus for a dryer of claim 1, wherein a water level sensor is installed at the water tank so as to detect a water level in the water tank.

9. The dehumidifying apparatus for a dryer of claim 8, further comprising:
a fresh water supply pipe for supplying a fluid from an external storage tank toward the heat exchanger; and
an opening/closing valve for opening and closing the fresh water supply pipe.

10. The dehumidifying apparatus for a dryer of claim 9, wherein if the water tank is detected to be in a high water level by the water level sensor, the opening/closing valve is activated to close the fresh water supply pipe.

11. The dehumidifying apparatus for a dryer of claim 1, wherein a water temperature sensor is installed at the water tank so as to detect water temperature in the water tank.

12. The dehumidifying apparatus for a dryer of claim 11, wherein it is determined whether or not fresh water is supplied to the heat exchanger from the water tank according to the detected water temperature by the water temperature sensor.

13. The dehumidifying apparatus for a dryer of claim 1, wherein the water tank is an air cooled water tank.

14. The dehumidifying apparatus for a dryer of claim 1, wherein the water tank is detachably mounted at the case.

15. The dehumidifying apparatus for a dryer of claim 1, wherein the water tank includes at least two receiving units disposed in a circulating direction of the fluid.

16. The dehumidifying apparatus for a dryer of claim 15, wherein each of the receiving units is hydraulically connected to adjacent receiving units so as to circulate the fluid.

17. The dehumidifying apparatus for a dryer of claim 15, wherein each of the receiving units is separated from each other by a partition wall disposed inside the water tank.
